(19) United States
(12) Patent Application Publication
(10) Pub. No.: US 2015/0163036 A1
(43) Pub. Date: Jun. 11, 2015

(54) High Resolution Channel Sounding for FDD Communications

(71) Applicant: Nokia Solutions and Networks Oy, Espoo (FI)

(72) Inventors: Timothy THOMAS, Palatine, IL (US); Frederick Vook, Schaumburg, IL (US); Weidong Yang, Hoffman Estates, IL (US)

(73) Assignee: Nokia Solutions and Networks Oy, Espoo (FI)

(21) Appl. No.: 14/103,197

(22) Filed: Dec. 11, 2013

(51) Int. Cl. H04L 5/00; H04L 5/14

(52) U.S. Cl. CPC H04L 5/0051; H04L 5/14; H04L 5/0005

(57) ABSTRACT

A method includes scheduling a selected UE operating in a FDD mode to transmit sounding information on a downlink carrier frequency using selected resource(s) from a downlink radio frame, and communicating using the downlink radio frame by transmitting to UEs in resources other than at least the selected resource(s) and by receiving the sounding information on the downlink carrier frequency from the selected UE in the selected resource(s). Another method includes scheduling a selected UE operating in a FDD mode to receive sounding information on an uplink carrier frequency using selected resource(s) from an uplink radio frame, and communicating using the uplink radio frame by receiving from UEs in resources in the uplink radio frame other than at least the selected resource(s) and by transmitting the sounding information on the uplink carrier frequency to the selected UE in the selected resource(s). Apparatus and computer program products are also disclosed.

### TECHNICAL FIELD

This invention relates generally to wireless communications and, more specifically, relates to channel sounding in wireless communications.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below at the end of the specification but prior to the claims.

TDD and FDD are two different duplexing modes of the same LTE standard. Put simply, the difference is that a device in FDD mode uses two frequency bands, one for communications to and the other for communications from the network, while a device in TDD mode uses only one frequency band for both communications.

Sounding is a process where known information, such as symbols, is transmitted using a frequency band from a first device to a second device. This information allows the second device to determine properties of channel relative to that frequency band. A benefit of the TDD mode is that sounding is performed using the same frequency band that is used to transmit and receive. Thus, if a UE transmits sounding information, such as SRS, to a base station, the base station can determine channel properties for the same frequency band that the base station will use to transmit to the UE. Similarly, if the base station transmits sounding information to a UE, the UE can determine channel properties for the same frequency band that the UE will use to transmit to the base station.

By contrast, for the FDD mode, the sounding is transmitted using a different frequency band than the band used to receive. Thus, if the base station transmits a signal known to a UE such as CRS or CSI-RS in DL to the UE using a DL frequency band, the UE can determine channel properties for this DL frequency band, but cannot reciprocate the process, as the UL frequency band is different from the DL frequency band. That is, even if the UE transmits sounding information in UL using an UL frequency band, the base station cannot determine channel properties for the DL frequency band (but can determine properties of the UL frequency band).

To enable the base station to determine some properties of the DL frequency band as seen by the UE using an FDD mode, the UE feeds back a relatively small amount of information, such as PMI, which provides the base station some information about the channel properties of the DL frequency band. In particular, the PMI maps to one or more codebook entries, where the codebook entries contain information that will be applied by the base station to antennas of the base station. Consequently, the PMI is an indication from the UE as to the best codebook entry or entries, which are themselves effectively indications of the channel properties as seen by the UE of the DL frequency band.

However, the PMI and the codebook entries are discrete. For instance, two bits for PMI allows a maximum of four codebook entries, three bits for PMI allows a maximum of eight code book entries, and the like. For systems with many antennas at the base station (or at the UE), this structure can be limiting yet also quite complex. Codebooks for greater than eight antennas are not yet defined by LTE standards, as an example, and precoding for eight antennas requires determining the product of two matrices. For systems with larger numbers of antennas (e.g., 100 antennas), the current CSI feedback techniques can be problematic.

### SUMMARY

This section contains examples of possible implementations and is not meant to be limiting.

In an exemplary embodiment, a method comprises: scheduling a selected user equipment operating in a frequency division duplexing mode to transmit sounding information on a downlink carrier frequency using one or more selected resources from a downlink radio frame; and communicating using the downlink radio frame by transmitting to user equipment in resources in the downlink radio frame other than at least the one or more selected resources and by receiving the sounding information on the downlink carrier frequency from the selected user equipment in the one or more selected resources of the downlink radio frame.

A method as above, wherein communicating further comprises not transmitting on guard periods occupying resources adjacent to the one or more selected resources of the downlink radio frame. A method as in this paragraph, wherein each of the guard periods and the sounding information comprises an orthogonal frequency division multiplexing symbol.

A method as above, further comprising, prior to communicating, coordinating with adjacent cells the scheduling of the selected user equipment operating in the frequency division duplexing mode to transmit sounding information using the one or more selected resources from a downlink radio frame. A method as in this paragraph, wherein coordinating further comprises sending to the adjacent cells indications of at least one or more slot numbers and one or more orthogonal frequency division multiplexing symbols to be used by the selected user equipment operating in the frequency division duplexing mode to transmit sounding information.

A method as above, wherein the radio frame is one of the following: a radio frame in a time-frequency resource structure, a radio frame comprising a multicast-broadcast single frequency network subframe, or a radio frame comprising a new carrier type frame. A method as above, further comprising using the received sounding information to tailor transmission of a future downlink transmission to the user equipment.

In a further exemplary embodiment, a computer program product comprises a computer-readable storage medium bearing computer program code embodied therein for use with a computer, the computer program code comprising code for performing any of the methods above.

In another exemplary embodiment, an apparatus comprises a means for performing any of the methods above.

In an additional exemplary embodiment, an apparatus comprises one or more processors and one or more memories including computer program code. The one or more memories and the computer program code are configured, with the one or more processors, to cause the apparatus to perform at least the following: scheduling a selected user equipment operating in a frequency division duplexing mode to transmit sounding information on a downlink carrier frequency using one or more selected resources from a downlink radio frame; and communicating using the downlink radio frame by transmitting to user equipment in resources in the downlink radio frame other than at least the one or more selected resources and by receiving the sounding information on the downlink carrier frequency from the selected user equipment in the one or more selected resources of the downlink radio frame.

An apparatus as above, wherein communicating further comprises not transmitting on guard periods occupying resources adjacent to the one or more selected resources of the downlink radio frame. An apparatus as of this paragraph wherein each of the guard periods and the sounding information comprises an orthogonal frequency division multiplexing symbol.

An apparatus as above, wherein the one or more memories and the computer program code are further configured, with the one or more processors, to cause the apparatus to perform at least the following: prior to communicating, coordinating with adjacent cells the scheduling of the selected user equipment operating in the frequency division duplexing mode to transmit sounding information using the one or more selected resources from a downlink radio frame. An apparatus as in this paragraph, wherein coordinating further comprises sending to the adjacent cells indications of at least one or more slot numbers and one or more orthogonal frequency division multiplexing symbols to be used by the selected user equipment operating in the frequency division duplexing mode to transmit sounding information.

An apparatus as above, wherein the radio frame is one of the following: a radio frame in a time-frequency resource structure, a radio frame comprising a multicast-broadcast single frequency network subframe, or a radio frame comprising a new carrier type frame. An apparatus as above, wherein the one or more memories and the computer program code are further configured, with the one or more processors, to cause the apparatus to perform at least the following: using the received sounding information to tailor transmission of a future downlink transmission to the user equipment.

A further exemplary embodiment includes a method, comprising: determining, at a user equipment operating in a frequency division duplexing mode, scheduling requesting the user equipment transmit sounding information on a downlink carrier frequency using one or more selected resources from a downlink radio frame; and transmitting the sounding information from the user equipment on the downlink carrier frequency in the one or more selected resources of the downlink radio frame.

A method as above, wherein the transmitted sounding information comprises sounding reference symbols sent on the downlink carrier frequency from at least one transmit antenna that is a same as at least one antenna used to the receive regular downlink transmissions. A method as in this paragraph, wherein the sounding reference symbols are sent from two or more transmit antennas which are the same antennas as ones used to receive the regular downlink transmissions. A method as in this paragraph, wherein the sounding reference symbols are orthogonal in time between pairs of antennas.

A method as above, wherein transmitting further comprises transmitting the sounding information using an orthogonal frequency division multiplexing symbol occupying a symbol length of an orthogonal frequency division multiplexing symbol in the downlink radio frame. A method as above, wherein the radio frame is one of the following: a radio frame in a time-frequency resource structure, a radio frame comprising a multicast-broadcast single frequency network subframe, or a radio frame comprising a new carrier type frame.

A further exemplary embodiment is a computer program product comprising a computer-readable storage medium bearing computer program code embodied therein for use with a computer, the computer program code comprising code for performing a method as above. In another exemplary embodiment, an apparatus comprises a means for performing any of the methods above.

An additional exemplary embodiment is an apparatus comprising one or more processors and one or more memories including computer program code. The one or more memories and the computer program code are configured, with the one or more processors, to cause the apparatus to perform at least the following: determining, at a user equipment operating in a frequency division duplexing mode, scheduling requesting the user equipment transmit sounding information on a downlink carrier frequency using one or more selected resources from a downlink radio frame; and transmitting the sounding information from the user equipment on the downlink carrier frequency in the one or more selected resources of the downlink radio frame.

An apparatus as above, wherein the transmitted sounding information comprises sounding reference symbols sent on the downlink carrier frequency from at least one transmit antenna that is a same as at least one antenna used to the receive regular downlink transmissions. An apparatus of this paragraph, wherein the sounding reference symbols are sent from two or more transmit antennas which are the same antennas as ones used to receive the regular downlink transmissions. An apparatus of this paragraph, wherein the sounding reference symbols are orthogonal in time between pairs of antennas.

An apparatus as above, wherein transmitting further comprises transmitting the sounding information using an orthogonal frequency division multiplexing symbol occupying a symbol length of an orthogonal frequency division multiplexing symbol in the downlink radio frame.

An apparatus as above, wherein the radio frame is one of the following: a radio frame in a time-frequency resource structure, a radio frame comprising a multicast-broadcast single frequency network subframe, or a radio frame comprising a new carrier type frame.

A further exemplary embodiment is a method comprising: scheduling a selected user equipment operating in a frequency division duplexing mode to receive sounding information on an uplink carrier frequency using one or more selected resources from an uplink radio frame; and communicating using the uplink radio frame by receiving from user equipment in resources in the uplink radio frame other than at least the one or more selected resources and by transmitting the sounding information on the uplink carrier frequency to the selected user equipment in the one or more selected resources of the uplink radio frame.

A method as above, wherein communicating further comprises not transmitting on guard periods occupying resources adjacent to the one or more selected resources of the uplink radio frame. A method as in this paragraph, wherein each of the guard periods and the sounding information comprises an orthogonal frequency division multiplexing symbol.

A method as above, further comprising, prior to communicating, coordinating with adjacent cells the scheduling of the selected user equipment operating in the frequency division duplexing mode to receive sounding information using the one or more selected resources from a uplink radio frame. A method as above, wherein coordinating further comprises sending to the adjacent cells indications of at least one or more slot numbers and one or more uplink symbols to be used by the selected user equipment operating in the frequency division duplexing mode to receive sounding information. A method as in this paragraph, wherein the uplink symbols are one of orthogonal frequency division multiplexing symbols or single-carrier frequency-division multiple access symbols.

A method as above, wherein the radio frame is one of the following: a radio frame in a time-frequency resource structure, a radio frame comprising a multicast-broadcast single frequency network subframe, or a radio frame comprising a new carrier type frame.

A further exemplary embodiment is a computer program product comprising a computer-readable storage medium bearing computer program code embodied therein for use with a computer, the computer program code comprising code for performing any of the methods as above. In another exemplary embodiment, an apparatus comprises a means for performing any of the methods above.

An additional exemplary embodiment is an apparatus comprising one or more processors and one or more memories including computer program code. The one or more memories and the computer program code are configured, with the one or more processors, to cause the apparatus to perform at least the following: scheduling a selected user equipment operating in a frequency division duplexing mode to receive sounding information on an uplink carrier frequency using one or more selected resources from an uplink radio frame; and communicating using the uplink radio frame by receiving from user equipment in resources in the uplink radio frame other than at least the one or more selected resources and by transmitting the sounding information on the uplink carrier frequency to the selected user equipment in the one or more selected resources of the uplink radio frame.

An apparatus as above, wherein communicating further comprises not transmitting on guard periods occupying resources adjacent to the one or more selected resources of the uplink radio frame. An apparatus as in this paragraph, wherein each of the guard periods and the sounding information comprises an orthogonal frequency division multiplexing symbol.

An apparatus as above, wherein the one or more memories and the computer program code are further configured, with the one or more processors, to cause the apparatus to perform at least the following: prior to communicating, coordinating with adjacent cells the scheduling of the selected user equipment operating in the frequency division duplexing mode to receive sounding information using the one or more selected resources from a uplink radio frame.

An apparatus as above, wherein coordinating further comprises sending to the adjacent cells indications of at least one or more slot numbers and one or more uplink symbols to be used by the selected user equipment operating in the frequency division duplexing mode to receive sounding information. An apparatus of this paragraph, wherein the uplink symbols are one of orthogonal frequency division multiplexing symbols or single-carrier frequency-division multiple access symbols.

An apparatus as above, wherein the radio frame is one of the following: a radio frame in a time-frequency resource structure, a radio frame comprising a multicast-broadcast single frequency network subframe, or a radio frame comprising a new carrier type frame.

A further exemplary embodiment is a method comprising: determining, at a user equipment operating in a frequency division duplexing mode, scheduling from a base station requesting the user equipment receive sounding information on an uplink carrier frequency using one or more selected resources from an uplink radio frame; and receiving the sounding information sent on the uplink carrier frequency from the base station in the one or more selected resources of the uplink radio frame.

A method as above, further comprising using the received sounding information to tailor the transmission of a future uplink transmission to the base station. A method as above, wherein receiving further comprises receiving the sounding information using one or more orthogonal frequency division multiplexing symbols, each occupying a symbol length of an orthogonal frequency division multiplexing symbol in the uplink radio frame. A method as above, wherein receiving further comprises receiving the sounding information using one or more orthogonal frequency division multiplexing symbols, each occupying one-half of a symbol length of a first orthogonal frequency division multiplexing symbol in the uplink radio frame and one-half of a symbol length of a second orthogonal frequency division multiplexing symbol in the uplink radio frame. A method as above, wherein the radio frame is one of the following: a radio frame in a time-frequency resource structure, a radio frame comprising a multicast-broadcast single frequency network subframe, or a radio frame comprising a new carrier type frame.

An additional exemplary embodiment is a computer program product comprising a computer-readable storage medium bearing computer program code embodied therein for use with a computer, the computer program code comprising code for performing any of the methods as above. In a further exemplary embodiment, an apparatus comprises a means for performing any of the methods above.

Another exemplary embodiment is an apparatus comprising one or more processors and one or more memories including computer program code. The one or more memories and the computer program code are configured, with the one or more processors, to cause the apparatus to perform at least the following: determining, at a user equipment operating in a frequency division duplexing mode, scheduling from a base station requesting the user equipment receive sounding information on an uplink carrier frequency using one or more selected resources from an uplink radio frame; and receiving the sounding information sent on the uplink carrier frequency from the base station in the one or more selected resources of the uplink radio frame.

An apparatus as above, wherein the one or more memories and the computer program code are further configured, with the one or more processors, to cause the apparatus to perform at least the following: using the received sounding information to tailor the transmission of a future uplink transmission to the base station. An apparatus as above, wherein receiving further comprises receiving the sounding information using one or more orthogonal frequency division multiplexing symbols, each occupying a symbol length of an orthogonal frequency division multiplexing symbol in the uplink radio frame. An apparatus as above, wherein receiving further comprises receiving the sounding information using one or more orthogonal frequency division multiplexing symbols, each occupying one-half of a symbol length of a first orthogonal frequency division multiplexing symbol in the uplink radio frame and one-half of a symbol length of a second orthogonal frequency division multiplexing symbol in the uplink radio frame. An apparatus as above, wherein the radio frame is one of the following: a radio frame in a time-frequency resource structure, a radio frame comprising a multicast-broadcast single frequency network subframe, or a radio frame comprising a new carrier type frame.

### BRIEF DESCRIPTION OF THE DRAWINGS

In the attached Drawing Figures:

FIG. 1A illustrates an exemplary system in which the exemplary embodiments may be practiced;

FIG. 1B illustrates an example of an antenna array panel;

FIG. 2 is an example of a frame structure type 1 and an example of puncturing a slot to provide for FDD DL-frequency sounding in accordance with an exemplary embodiment;

FIG. 3 is an example of frame structure type 2 (for 5 ms switch-point periodicity) and is a version of FIGS. 4.2-1 from 3GPP TS 36.211 V11.4.0 (2013-09);

FIG. 4 is Table 4.2-1, configuration of special subframe (lengths of DwPTS/GP/UpPTS), from 3GPP TS 36.211 V11.4.0 (2013-09);

FIG. 5 is Table 4.2-2, uplink-downlink configurations, from 3GPP TS 36.211 V11.4.0 (2013-09);

FIG. 6A is an alternate example of a slot for FDD DL-frequency sounding or FDD UL-frequency sounding requiring puncturing of only two OFDM symbols;

FIG. 6B is an example of a FDD DL-frequency sounding reference signal format;

FIG. 7 is a block diagram of an exemplary logic flow diagram performed by a base station for FDD DL-frequency sounding that illustrates the operation of an exemplary method, a result of execution of computer program instructions embodied on a computer readable memory, and/or functions performed by logic implemented in hardware, in accordance with exemplary embodiments herein;

FIG. 8 is a block diagram of an exemplary logic flow diagram performed by a user equipment for FDD DL-frequency sounding that illustrates the operation of an exemplary method, a result of execution of computer program instructions embodied on a computer readable memory, and/or functions performed by logic implemented in hardware, in accordance with exemplary embodiments herein;

FIG. 9 is an example of puncturing of a slot for FDD UL-frequency sounding using CSI-RS for sounding;

FIG. 10 is an alternate example of puncturing of a slot for FDD UL-frequency sounding using CSI-RS for sounding with smaller guard period;

FIG. 11 illustrates CSI-RS-based FDD UL-frequency sounding for the format illustrated in FIG. 9, where the sounding enables sounding of up to 24 transmit antennas and where frequency is along the y-axis and time is along the x-axis;

FIG. 12 is a block diagram of an exemplary logic flow diagram performed by a base station for FDD UL-frequency sounding that illustrates the operation of an exemplary method, a result of execution of computer program instructions embodied on a computer readable memory, and/or functions performed by logic implemented in hardware, in accordance with exemplary embodiments herein;

FIG. 13 is a block diagram of an exemplary logic flow diagram performed by a user equipment for FDD UL-frequency sounding that illustrates the operation of an exemplary method, a result of execution of computer program instructions embodied on a computer readable memory, and/or functions performed by logic implemented in hardware, in accordance with exemplary embodiments herein.

### DETAILED DESCRIPTION OF THE DRAWINGS

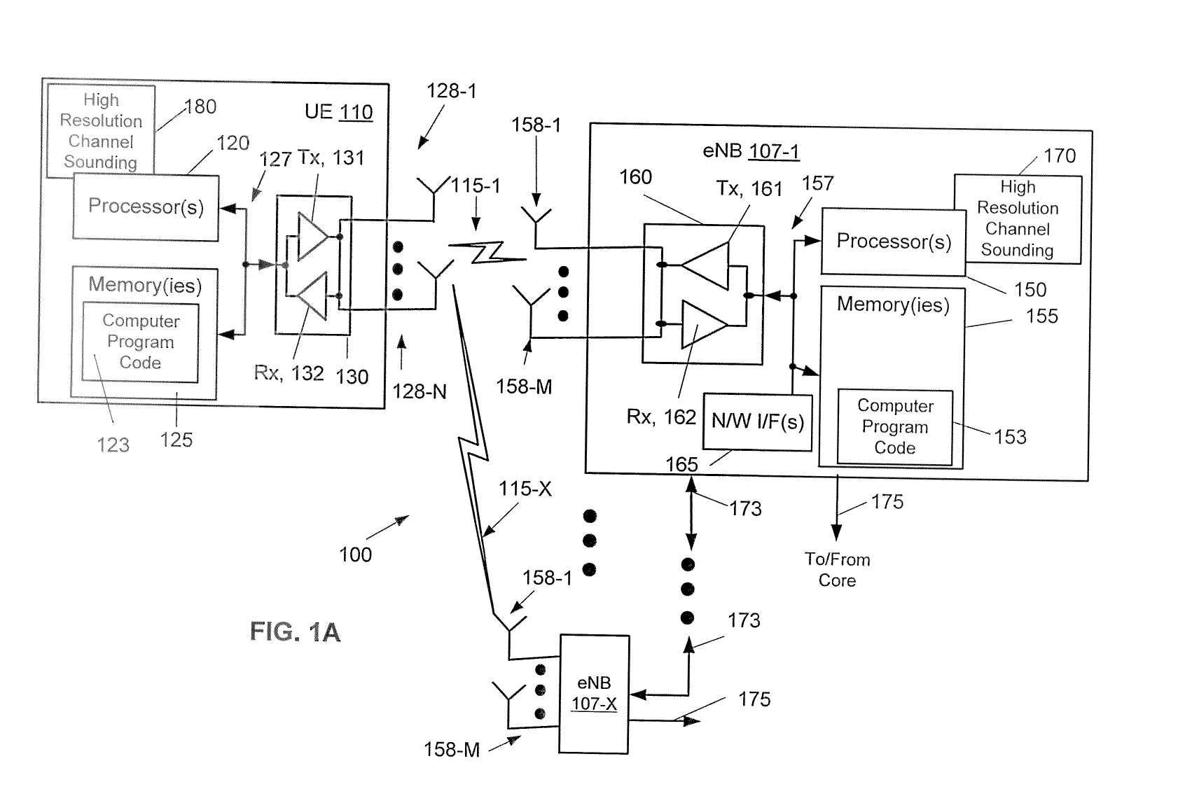

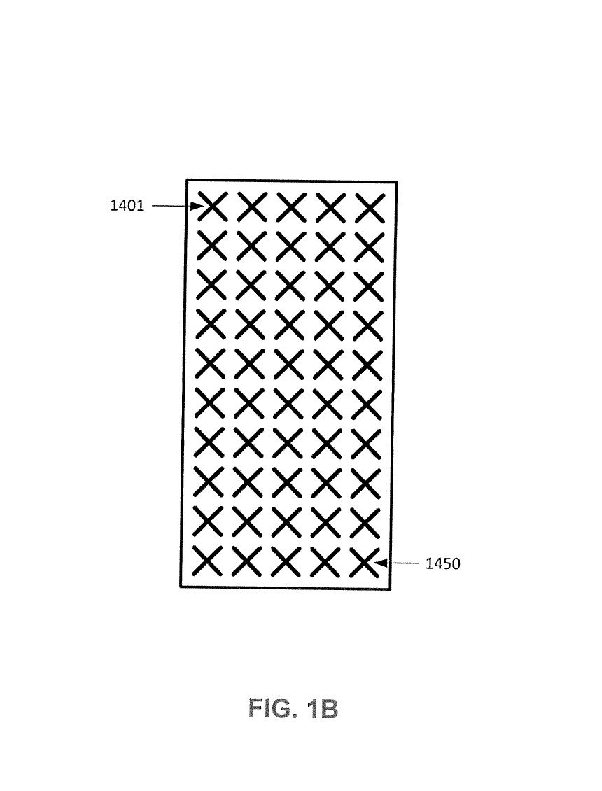

Before proceeding with description of additional problems with conventional systems and how exemplary embodiments address these problems, reference is now made to FIG. 1A, which illustrates an exemplary system in which the exemplary embodiments may be practiced. In FIG. 1A, a user equipment (UE) 110 is in wireless communication with a wireless network 100 via a wireless link 115-1 with eNB 107-1, which is an LTE base station (in this example) providing access to and from the wireless network 100. In another exemplary embodiment, the UE 110 may be in wireless communication with the wireless network 100 using X wireless links 115-1 through 115-X and eNBs 107-1 through 107-X, respectively.

The user equipment 110 includes N antennas 128-1 through 128-N, one or more processors 120, one or more memories 125, and one or more transceivers 130, interconnected using one or more buses 127. The one or more buses 127 may be any physical devices for interconnecting electronic elements, such as traces on a board, metal or other conductive runs on an integrated circuit, optic channels or elements, and the like. Each of the one or more transceivers 130 includes one or more transmitters (Tx) 131, one or more receivers (RX) 132, or both. The one or more memories include computer program code 123. The UE 110 also includes a high resolution channel sounding process 180. The high resolution channel sounding process 180 may be implemented via the computer program code 123, such that the one or more memories 125 and the computer program code 123 are configured to, with the one or more processors 120, cause the eNB 107-1 to perform one or more of the operations as described herein. The high resolution channel sounding process 180 may be implemented as hardware logic, such as in an integrated circuit, gate array or other programmable device, discrete circuitry, and the like. The high resolution channel sounding process 180 could be implemented through some combination of computer program code 123 and hardware logic.

The wireless network 100 includes the eNB 107-1 or may include the X eNBs 107. Although an LTE base station is used herein as an example, the exemplary embodiments are applicable to other wireless transmission systems. Each eNB 107 is assumed to be similar, so only the exemplary internals of eNB 107-1 are shown. The eNB 107-1 includes M antenna 158-1 through 158-M. The eNB 107-1 includes one or more processors 150, one or more memories 155, one or more network interfaces (N/W I/F(s)) 165, and one or more transceivers 160 (each comprising a transmitter, Tx, 161 and a receiver, Rx, 162) interconnected through one or more buses 157. The one or more buses 157 may be any physical devices for interconnecting electronic elements, such as traces on a board, metal or other conductive runs on an integrated circuit, optic channels or elements, and the like. The one or more transceivers are connected to the antennas 158. The one or more memories 155 include computer program code 153. The eNB 107-1 includes a high resolution channel sounding process 170. The high resolution channel sounding process 170 may be implemented via the computer program code 153, such that the one or more memories 155 and the computer program code 153 are configured to, with the one or more processors 150, cause the eNB 107-1 to perform one or more of the operations as described herein. The high resolution channel sounding process 170 may be implemented as hardware logic, such as in an integrated circuit, gate array or other programmable device, discrete circuitry, and the like. The high resolution channel sounding process 170 could be implemented through some combination of computer program code 153 and hardware logic.

The one or more network interfaces 165 communicate over networks such as the networks 173, 175. The eNB 107-1 may communicate with other eNBs 107 using, e.g., network 173. The network 173 may be wired or wireless or both and may implement, e.g., an X2 interface. The eNB 107 may use the network 175 to communicate with a core portion of the wireless network 100.

For ease of reference, it is assumed that each eNB 107 has M antennas, but this is not a limitation and eNBs 107 may have a different number of antennas. In an exemplary embodiment, the eNB 107-1 includes a “large” number of antennas, such as 8, 16, or even 100 (or more) antennas. FIG. 1B shows an example of an antenna array panel at eNB 107 where M=100 antennas. In this example there are 50 co-located radiating antenna elements (1401 to 1450) in the panel where each co-located element consists of a pair of antennas, one which transmits with a +45 degree polarization and the other which transmits with a −45 degree polarization. Thus there are a total of 2×50=100 individual elements in the panel. While this number of elements may seem very large, current panels at eNBs already have around 10 elements in the vertical dimension. The only difference is that currently these elements cannot be individually controlled at baseband with different signals, but each group of vertical elements (for a single azimuth dimension and a single polarization) transmits the same signal. There would only be a single gain and phase difference on each element which would multiply the common signal to give the desired properties of the beam created in the vertical direction. In contrast full baseband control of each element would give complete control in transmitting and receiving signals in both the azimuth and elevation dimensions. This control of a large number of antennas is what is needed for the operation of massive MIMO (also known as full-dimension MIMO). In another exemplary embodiment, the eNBs 107 exchange information received from each eNB's antennas and process the information. Thus, each eNB 107 may have a limited number of antennas (e.g., such as a few antennas), but each eNB 107 is able to access information from many antennas.

The computer readable memories 125 and 155 may be of any type suitable to the local technical environment and may be implemented using any suitable data storage technology, such as semiconductor based memory devices, flash memory, magnetic memory devices and systems, optical memory devices and systems, fixed memory and removable memory. The processor(s) 120 and 150 may be of any type suitable to the local technical environment, and may include one or more of general purpose computers, special purpose computers, general or special purpose integrated circuits, microprocessors, digital signal processors (DSPs) and processors based on a multi-core processor architecture, as non-limiting examples.

In general, the various embodiments of the user equipment 110 can include, but are not limited to, cellular telephones such as smart phones, tablets, “phablets”, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

As described above, for systems with larger numbers of antennas (e.g., 100 antennas as in FIG. 1B), the current sounding techniques can be problematic. For instance, it is well known that the current codebook feedback for FDD has the following limitations:

1) The resolution of the codebooks (especially for four transmit antennas) is insufficient for good MU-MIMO operation. The difficulty is that the codebooks are too coarse to be able to steer deep nulls towards UEs sharing the same time-frequency resource. In general, system simulations show that SU-MIMO will perform closely with respect to MU-MIMO when using codebook feedback, however with higher resolution feedback, MU-MIMO will out-perform SU-MIMO (e.g., using SRS in a TDD system).

2) The codebooks are only defined for a small number of transmit antennas (two, four, or eight) and thus are not suited for an increase in the number of transmit antennas for future techniques like elevation beamforming and full-dimension MIMO (also known as massive MIMO which may have baseband processing behind all azimuth and elevation antennas in an array and may have up to 100 antennas or more). To accommodate more antennas, new codebooks would need to be defined and to be able to accommodate a very large number of antennas a substantial increase in feedback would be needed.

3) The codebook size for an increased number of transmit antennas would have to be very large to get sufficient resolution even for SU-MIMO, thus requiring very large amounts of feedback, and this involves considerable codebook search effort on the UE side.

In order to reduce or solve these problems, exemplary embodiments herein propose signaling, physical layer procedures, and network coordination to enable uplink (UL) sounding on the same frequency as used in the downlink (DL) of an FDD system (called FDD DL-frequency sounding) and also enable DL sounding on the same frequency used in the UL of an FDD system (called FDD UL-frequency sounding). Illustratively, exemplary embodiments solve the problem of obtaining high resolution CSI in an FDD system without requiring excessive amounts of feedback and/or reference-signal resources. For example if a UE has N=2 antennas, only two reference-signal sequences (CSI-RS) need to be sent in FDD DL-frequency sounding as opposed to the eNB with M=100 antennas needing to send 100 reference-signal sequences (CSI-RS) on the DL to enable the UE to determine FDD codebook feedback. In addition a codebook defined for 100 antenna elements would need to be defined and the UE would have to expend an extreme amount of computational resources in determining the best codebook element from that codebook. One aspect leverages the existing sounding paradigm of LTE, but instead of the UE 110 transmitting the UL sounding on the frequency assigned to the UL for the FDD system, the UE transmits the sounding signal on the DL frequency using the same antennas the UE 110 receives on in the DL. With previous release UEs (less than release 12) the UEs would not be able to transmit on the DL frequency for a few reasons including not being physically designed to transmit at those frequencies, but also because of the unpredictable interference the transmission would cause to the systems. However, having the UE transmit on different carrier frequencies is already enabled in the devices since systems, such as LTE, typically operate in more than one frequency band. The UE would only need to tune its transmitter to additional frequencies given by the set of possible DL frequencies. Thus, enabling future UEs to transmit on the DL frequency along with the UL frequency should be straightforward. However, what is still missing is the signaling and protocols needed for the UE to sound on the DL frequency without undue interference to/from the system.

The exemplary embodiments that enable the UE 110 to transmit its SRS on the DL frequency (or the eNB to transmit sounding on the UL frequency) have the following exemplary and non-limiting benefits:

1) The ability to get high-resolution CSI for any number of eNB transmit antennas in an FDD system. The high-resolution CSI occurs because the techniques do not rely on codebooks (which by definition cause quantization and for a large number of antennas, severe quantization), instead all antennas may be used for CSI determination, and the resolution is limited only by, e.g., the A/D (analog to digital) system and the signal-to-noise ratio. The exemplary embodiments thus address the issue of elevation beamforming and full-dimension MIMO, where a very large number of transmit antennas will be controllable at the eNB (e.g., with baseband processing behind all antennas).

2) MU-MIMO performance will be greatly improved with higher resolution feedback regardless of the number of transmit antennas (i.e., much improved performance even for four transmit antennas). In exemplary embodiments, the techniques will enable more accurate nulls to be steered towards the UEs, thus significantly improving the MU-MIMO performance.

3) Improved frequency-selective scheduling on the downlink since the eNB 107 can get very accurate frequency-selective downlink channel estimates.

4) Future-proofs the LTE standards by enabling a method of obtaining very accurate CSI in FDD for any number of transmit antennas.

5) As long as the mobile device can sound from all of its antennas, the method enables sufficient feedback for interference alignment algorithms on the downlink, which significantly improve system-level capacity (as long as the CSI is frequency selective and of high enough resolution which would be enabled by the exemplary embodiments herein).

As stated above, exemplary embodiments herein propose signaling, physical layer procedures, and network coordination to enable uplink (UL) sounding on the same frequency as used in the downlink (DL) of an FDD system (called FDD DL-frequency sounding) and also enable DL sounding on the same frequency used in the UL of an FDD system (called FDD UL-frequency sounding). FDD DL-frequency sounding by the UE is described now, and the FDD UL-frequency sounding is described thereafter.

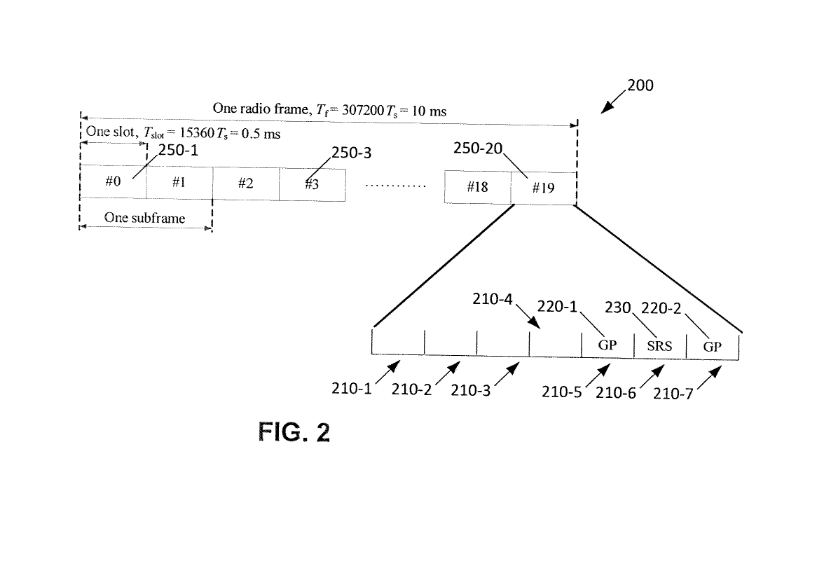

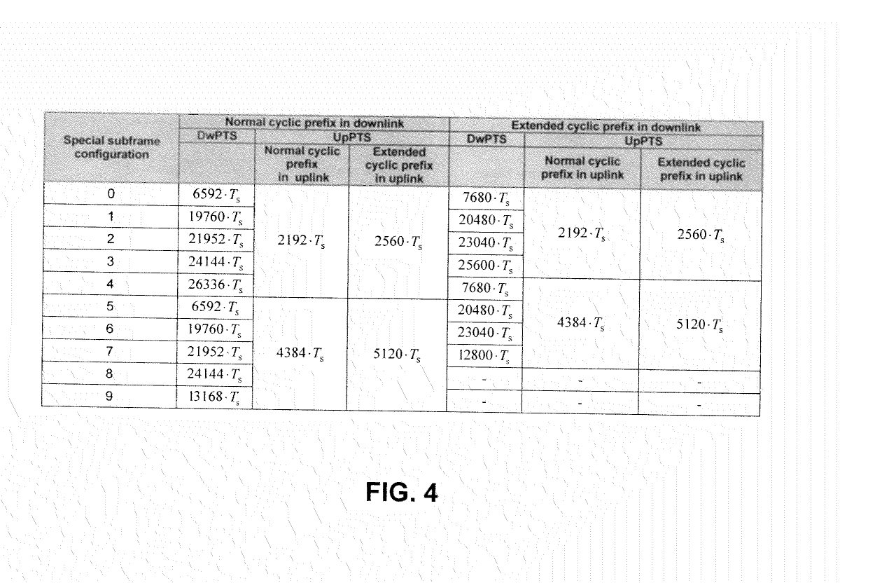

Concerning resources for FDD sounding and transmission timing derivation, a first aspect is to puncture the FDD downlink operation for a few OFDM symbols during which time the UE will be allowed to send sounding reference symbols (SRS) on the carrier frequency used for the DL. The FDD frame structure in LTE is shown in FIG. 2, which is an example of a frame structure type 1. Frame 200 is a copy of FIGS. 4.1-1 from 3GPP TS 36.211 V11.4.0 (2013-09). However, FIG. 2 also shows puncturing a slot to provide for FDD DL-frequency sounding in accordance with an exemplary embodiment.

There are 20 slots 250 and each slot 250 of the LTE frame 200 is composed of seven OFDM symbols 210 and an exemplary embodiment for FDD DL-frequency sounding replaces some of the OFDM symbols 210 in a slot with guard periods (GPs) (e.g., allowing for UL to DL and DL to UL switching at both the eNB and the UE) and the SRS. Legacy UEs would likely not be allowed to be scheduled in the subframe where FDD DL-frequency sounding was enabled due to the potential for significant interference. Non-legacy UEs would know that a slot 250 in the subframe was punctured to allow FDD DL-frequency sounding and would not expect data and reference symbols on those OFDM symbols.

An example of FDD DL-frequency sounding would be to puncture slot 19 250-20. The GP 220-1, 220-2 (in symbols 210-5 and 210-7, respectively) stands for a guard period (no transmissions at either the UE 110 or the eNB 107), SRS 230 is the sounding information in symbol 210-6, and the first four symbols 210-1 through 210-4 contain regular DL data/reference symbols transmitted by the eNB 107.

With the example shown in FIG. 2 some of the common reference symbols (CRSs) will not be transmitted by the eNB 107, as these CRS would normally be in the first guard period 220-1 (that is, in symbol 210-5). Several techniques are available for avoiding overlapping transmission of FDD sounding over CRS:

1. By puncturing symbols in a subframe for FDD sounding as shown in FIG. 2.

2. The chosen slot for FDD sounding can be in a multicast-broadcast single frequency network (MBSFN) subframe, where the CRS is transmitted at the beginning of a subframe. In this case, the whole slot/subframe except the symbols having CRS present can be used for FDD sounding.

3. In NCT (New Carrier Type) technology for LTE, decimated CRS in time and probably in frequency is used to provide timing/frequency track reference and potentially serves other purposes. As the occurrence of CRS is quite sparse in NCT, the chosen slot for FDD sounding can be located in non-MBSFN subframes. In this case the whole slot/subframe can be used for FDD sounding (of course, partial use of resources for FDD sounding is still available).

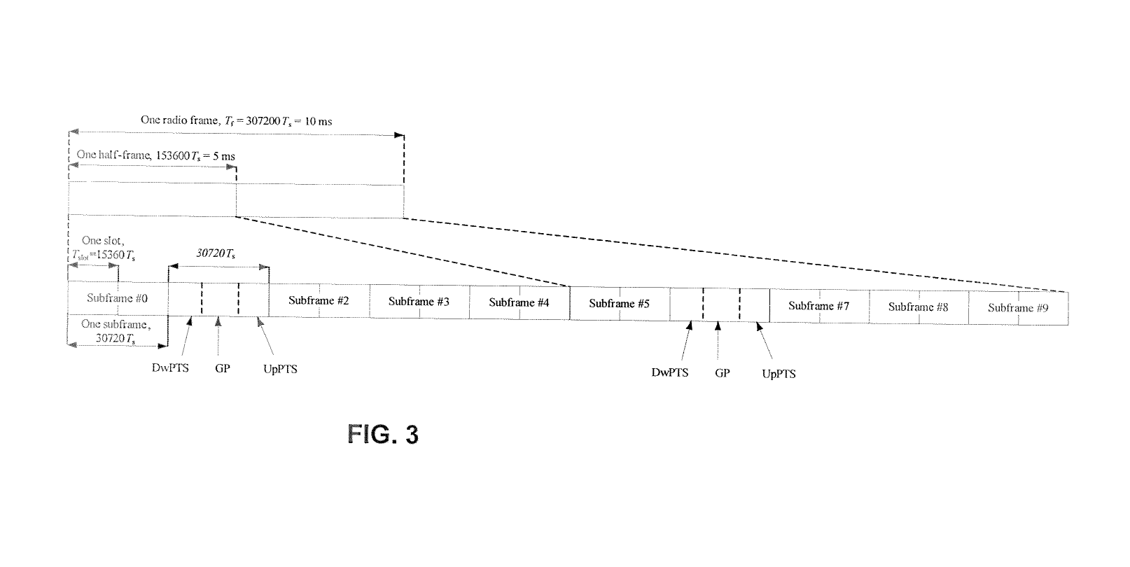

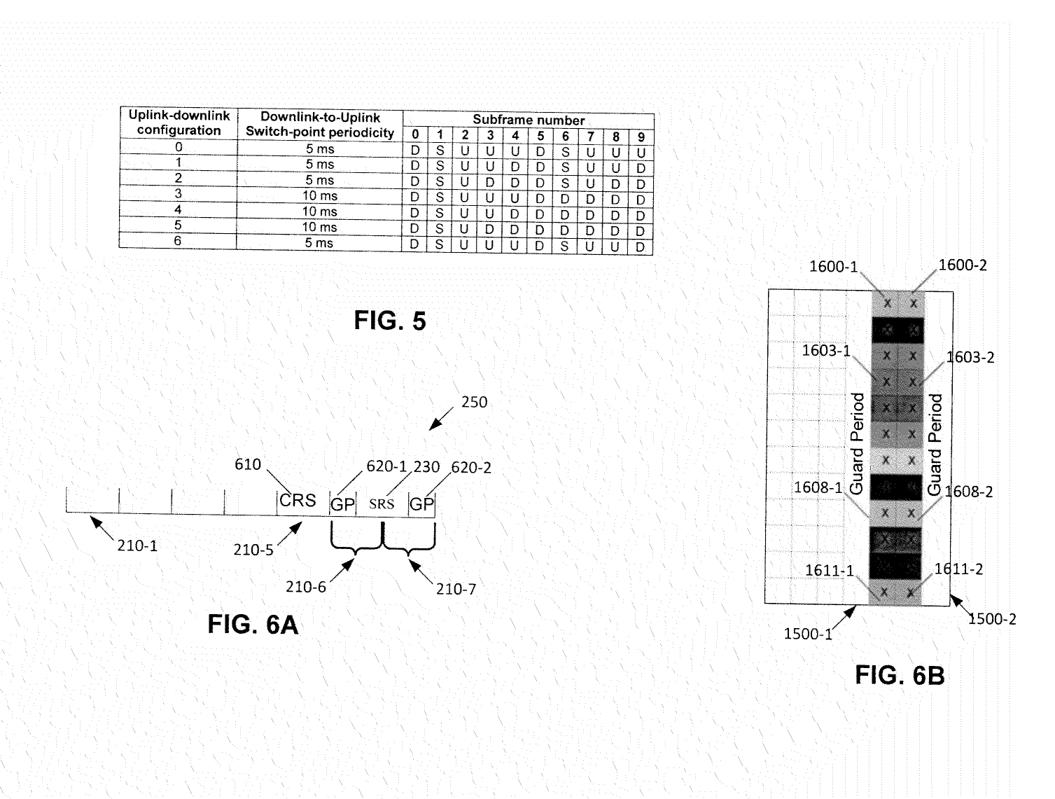

4. Some reference TDD UL/DL configuration can be used. In this case, the Rel-12 UE is configured to follow the reference TDD timing in terms of SRS transmission: in UpPTS or a regular nominal uplink subframes. The reference TDD timing can include a reference TDD UL/DL configuration and/or special subframe configuration. The configuration of UL/DL and special subframe follows FIG. 3 and two tables shown in FIGS. 4 and 5. FIG. 3 is an example of frame structure type 2 (for 5 ms switch-point periodicity) and is a version of FIGS. 4.2-1 from 3GPP TS 36.211 V11.4.0 (2013-09). FIG. 4 is Table 4.2-1, Configuration of special subframe (lengths of DwPTS/GP/UpPTS), from 3GPP TS 36.211 V11.4.0 (2013-09). FIG. 5 is Table 4.2-2, Uplink-downlink configurations, from 3GPP TS 36.211 V11.4.0 (2013-09). In other words for FDD DL-frequency sounding a TDD UL/DL configuration with minimal subframe(s) for UL could be used where the UE transmits sounding in one or more subframes between the two guard periods (i.e., the UL period as noted in FIG. 3).

If the omission of the CRS will create problems with legacy UEs, then the FDD DL-frequency sounding shown in FIG. 6A could also be used. FIG. 6A is an alternate example of a slot 250 for FDD DL-frequency sounding or FDD UL-frequency sounding requiring puncturing of only two OFDM symbols 210-6 and 210-7. In this alternate example, the SRS 230 is still a full OFDM symbol length (e.g., in terms of time period) but each guard period 620-1, 620-2 is one half of an OFDM symbol length. It becomes desirable at other occasions that 620-1 and 620-2 have different lengths. For example, depending on the propagation delay from the UE to its serving cell, the necessary timing adjustment can be used so 620-1 is shorter than one half of an OFDM symbol. When transmitting the FDD DL-frequency sounding in this manner, the CRS is never omitted, since the CRS 610 would be in symbol 210-5.

If an MBSFN subframe or a subframe in NCT or reference TDD UL/DL configuration is used for FDD sounding, more than one FDD sounding opportunity can be included in a subframe. Hence, some timing offset should be indicated by the eNB 107 to the UE 110 to signal the starting time of the FDD sounding opportunity. Also, the SRS duration can be extended to boost the SRS link budget as more symbols are available now (e.g., if a whole slot is used for FDD sounding).

A configured MBSN or NCT subframe and reference TDD UL/DL configuration can be also used jointly. In LTE TDD uplink sounding, the last OFDMA symbol in an UL subframe is used. In contrast, multiple SRS opportunities can be defined in a FDD sounding UL subframe or a set of contiguous FDD sounding UL subframes. A UE can be signaled with the SRS opportunity (or opportunities) for the UE to use through RRC signaling and/or SIB message. Alternatively the association of a UE and its SRS opportunities can be established through a hash function which takes the UE ID as one input.

In release 10, aperiodic SRS transmission was introduced. For FDD sounding, the support for both periodic and aperiodic sounding can be continued. And a UE in a FDD LTE system can be configured to search and decode DCIs associated with a TDD system so the aperiodic triggering of SRS is supported.

Note that with FIG. 2 a larger guard period is used (71.4 sec) than with FIG. 6A (35.7 μsec). Even with 35.7 μsec there should be plenty of time for the UE and eNB to switch between UL and DL frequencies in the RF circuitry and also up to 10.7 km (35.7 μsec) of excess path delay would be enabled. That is, 10.7 km equates to 35.7 μsec travel time for an electromagnetic wave from the UE 110. Because the UE 110 is the only UE scheduled to transmit for the symbol(s) used for the SRS and no other UEs are scheduled to receive for those symbol(s), within a cell created by the eNB 107, there should be no interference caused by the UE 110. As described below the adjacent cells would likely also be enabling FDD DL-frequency sounding in the same slots, so interference from the UE transmitting SRS to UEs in the other cells would not occur. The concern is if the propagation of the SRS sent from the UE would travel long enough so that the SRS would be received during a regular DL slot at some UE in another cell (i.e., the SRS signal would be received at a future time corresponding to the time the signal takes to travel from the UE sending the interfering SRS signal to the UE in the other cell). The 12 km distance allows the signal from the UE to lessen in power (e.g., “die down”), so that the UE might not cause much interference for UEs in those distant cells. Alternatively the SRS transmit timing of the UE's is controlled by the eNB through a timing adjustment.

The exact location and duration of the FDD DL-frequency sounding should be configured through control channel messaging from the eNB 107 specifying, e.g., the slot number and OFDM symbol numbers for the sounding. The transmission timing can be derived according to an UL transmission, as the eNB is the intended destination. Also the exact nature of the sounding should be signaled to the UE as is the case currently with SRS.

FIG. 6B shows an example of a SRS format for FDD DL-frequency sounding shown in FIG. 2. The SRS format consists of pairs of SRS, 16xx-1 and 16xx-2, which are meant for sounding transmitted from a pair of UE antennas with guard periods 1500-1 and 1500-2 on either side of the SRS. For example if the UE only has two antennas to sound, the UE may sound using SRS 1600-1 and 1600-2 which are time-frequency resources such as a single subcarrier in a single OFDM symbol. The SRS for a pair would consist of two identical pilot symbols where one antenna sends the two pilot symbols and the other antenna sends the positive of the pilot symbol at the first time (e.g., 1600-1) and sends the negative of the pilot symbol at the second time (e.g., 1600-2). This SRS format can enable the UE to sound up to 24 UE antennas. For more than 24 antennas this format can be replicated in frequency and/or time but for antennas other than the first 24. If sounding of the entire frequency domain bandwidth is desired for the first 24 antennas then this format can be replicated across frequency where the original 24 antennas sounds the SRS in the replicated blocks.

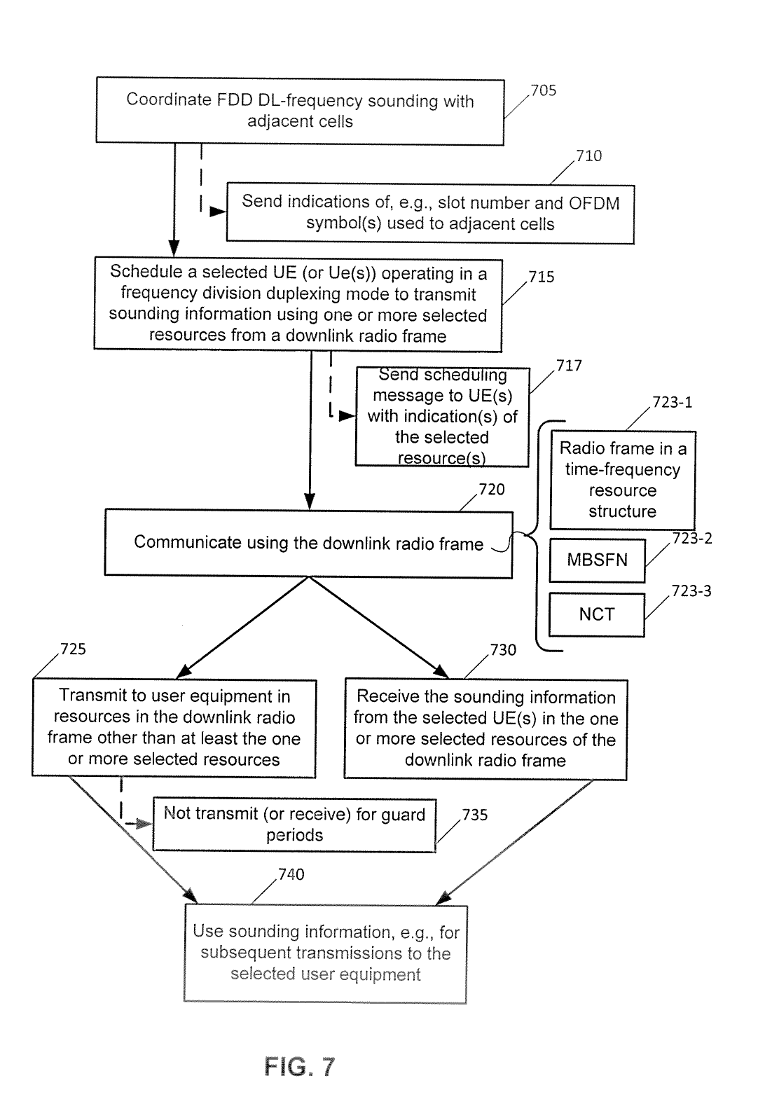

Turning to FIG. 7, this figure is a block diagram performed by a base station of an exemplary logic flow diagram for FDD DL-frequency sounding. This figure also illustrates the operation of an exemplary method, a result of execution of computer program instructions embodied on a computer readable memory, and/or functions performed by logic implemented in hardware, in accordance with exemplary embodiments herein. The blocks in FIG. 7 may also be considered to be interconnected for means of performing the functions in the blocks. FIG. 7 is assumed to be performed by the eNB 107-1, e.g., under control of the high resolution channel sounding process 170.

In block 705, the eNB 107 coordinates FDD DL-frequency sounding with adjacent cells. Regarding network-wide coordination of the FDD sounding/RF coordination, it is desirable in certain system 100 configurations that the entire network or a local subset of the network be configured to have the FDD DL-frequency sounding and the FDD UL-frequency sounding at the same time to minimize unwanted interference. In this case signaling may be needed across, e.g., the X2-interface (e.g., using network 173) to coordinate the FDD DL-frequency and FDD UL-frequency sounding methods. The coordination of FDD DL-frequency sounding in a network can be also achieved through OAM configuration. Besides mitigating unwanted interference, the coordinated FDD DL-frequency sounding provides another benefit whereby an adjacent cell detects and estimates the channel response from the DL-frequency SRS transmitted by a UE under the serving cell, and transmitted matrices for coordinated beamforming, interference alignment and the like are derived from the detected DL-frequency SRSs at multiple cells. To achieve this goal, the transmit power of DL SRS transmission can be controlled by the eNB through dynamic and/or semi-static signaling and/or defined in an LTE specification. In one example, the target for power control is the ability to detect the DL SRS at cells other than the serving cell. The local group of eNBs which are coordinating their FDD DL-frequency and/or FDD UL-frequency sounding might also want to configure some of its outer cells to not do FDD sounding at all so that neighboring cells outside the local subset which may have a different FDD sounding times will not be interfered with during normal DL or UL transmission.

In a cell, FDD sounding takes on a DL frequency where the UE transmits a sounding signal on the DL frequency, and the eNB is supposed to receive the sounding signal. If the adjacent cells are transmitting DL signals to their served UEs in their respective cells, then severe eNB-eNB interference can take place at the cell of interest. That is, the eNB 107 in the adjacent cell causes interference to the eNB in the cell performing the FDD DL-frequency sounding. As is typical there is a clear path between different cell towers and the propagation between two eNBs 107 is LoS, the interference can be quite severe. Even though the antenna pattern at eNB can be designed to have a null in the horizontal plane so eNBs at the same height do not suffer much from eNB-eNB interference, there is no guarantee in real deployment eNBs do have the same height. Consequently, it is desirable to coordinate the FDD sounding among cells so eNB-eNB interference is avoided for those configurations of system 100 where such interference might be problematic.

Consequently, in block 705, the eNB coordinates such DL-frequency sounding. For instance, the eNB 107 may send indications of, e.g., slot number and OFDM symbol(s) used for the DL-frequency sounding to adjacent cells (block 710). For instance, referring to FIG. 2, indications for the 19th slot 250-20 of a particular radio frame 200 and the indications of the OFDM symbols 210-5, 210-6 and 210-7 could be sent from the eNB 107 to adjacent eNBs 107. In this example, because three OFDM symbols are used, the adjacent eNBs know the structure is as shown in FIG. 2. Should the eNB send indications of only two OFDM symbols 210, the adjacent eNBs know the structure is as shown in FIG. 6A. It is noted that the radio frame may be one frame of a time-frequency resource structure that has a number of subcarriers. Indications could also be sent to indicate which of the subcarriers are to have the sounding information.

In block 715, the eNB 107 schedules a selected user equipment or multiple user equipment operating in a frequency division duplexing mode to transmit sounding information (e.g., SRS 230) using one or more selected resources (e.g., OFDM symbols 210) from a downlink radio frame 200. Such scheduling may involve (block 717) sending a scheduling message to one or more UEs with indication(s) of the selected resource(s). In block 720, the eNB 107 communicates using the downlink radio frame. The radio frame may be a radio frame in a time-frequency resource structure (block 723-1), an MBSFN frame (block 723-2) or an NCT frame (block 723-3).

Block 720 involves both blocks 725 and 730. In block 725, the eNB transmits to user equipment in resources in the downlink radio frame other than at least the one or more selected resources. In block 730, the eNB receives the sounding information from the selected user equipment in the one or more selected resources of the downlink radio frame. In terms of transmission in the radio frame 200, the eNB may transmit to the selected UE 110 and/or other UEs in the resources in the downlink radio frame other than at least the one or more selected resources. Only the selected UE or UEs will be scheduled to transmit on the one or more selected resources, and the eNB 107 will receive on those one or more scheduled resources. Additionally, the eNB 107, e.g., as part of transmitting in block 725, will also not transmit (or receive) for the guard periods 220, 620 (block 735). It is noted that the guard periods may not be used in certain instances, e.g., if no other DL transmission is performed by the eNB during the slot with the FDD DL-frequency sounding or if the TDD frame format of FIG. 3 is used where guard periods are already part of the frame structure. Although FIGS. 2 and 6 show a single SRS 230, it may be possible to use multiple SRS in a single radio frame 200 (e.g., as described above with respect to MBSFN frames).

In block 740, the eNB 107 uses the sounding information, e.g., for subsequent transmissions to the selected user equipment. For instance, the sounding information could be used to calculate precoding information that is applied to the antennas 158 of the eNB. The sounding could also be used for scheduling, in particular for frequency-selective scheduling where UEs are transmitted to on parts of the frequency-band which are most advantageous for that UE. Any of these methods for using the sounding information can be referred to as tailoring the downlink transmission to the user equipment based on the received sounding information.

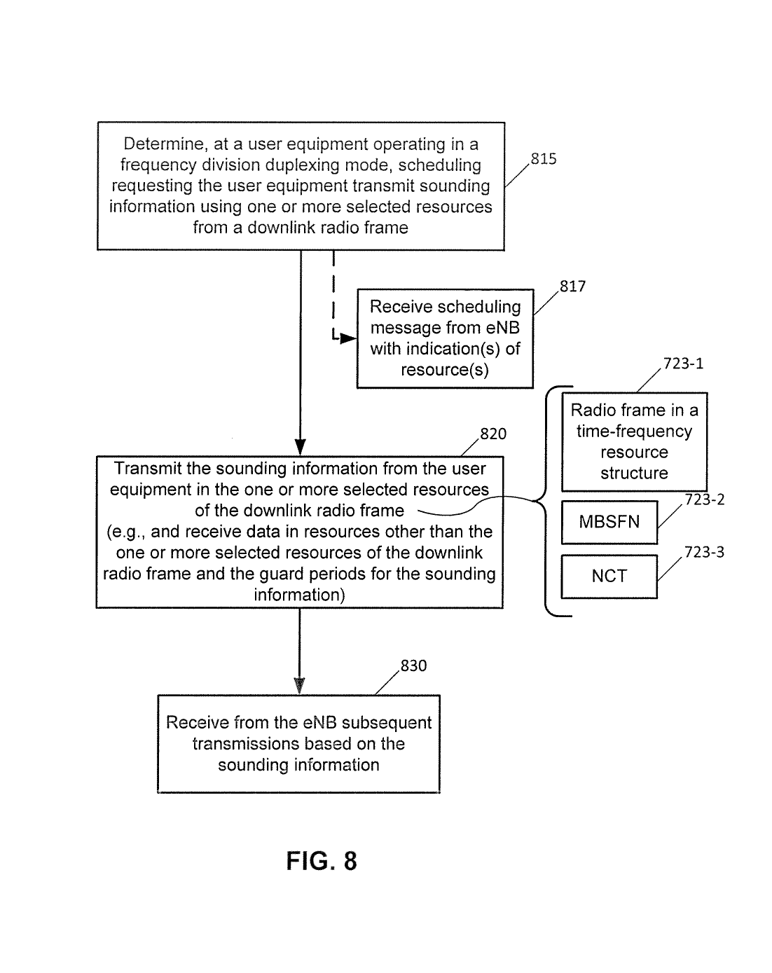

Turning to FIG. 8, FIG. 8 is a block diagram of an exemplary logic flow diagram performed by a user equipment for FDD DL-frequency sounding. This figure also illustrates the operation of an exemplary method, a result of execution of computer program instructions embodied on a computer readable memory, and/or functions performed by logic implemented in hardware, in accordance with exemplary embodiments herein. The blocks in FIG. 8 may be considered to be interconnected for means of performing the functions in the blocks. FIG. 8 is assumed to be performed by UE 110, e.g., under the control of the high resolution channel sounding process 180.

In block 815, the UE 110 determines, at the user equipment that is operating in a frequency division duplexing mode, scheduling requesting the user equipment transmit sounding information using one or more selected resources from a downlink radio frame. For example, the scheduling could be determined based on (block 817) a scheduling message received from the eNB with indication(s) of the resource(s) (e.g., where the indications are as described above with respect to block 710 of FIG. 7).

In block 820, the UE 110 transmits the sounding information from the user equipment in the one or more selected resources of the downlink radio frame. Examples of this are shown in FIGS. 2 and 6. The radio frame may be any of the radio frames 723. Note in block 820 that the UE 110 may receive data in resources other than the one or more selected resources of the downlink radio frame and the guard periods 220, 620 for the sounding information. In block 830, the UE 110 receives from the eNB subsequent transmissions based on the sounding information.

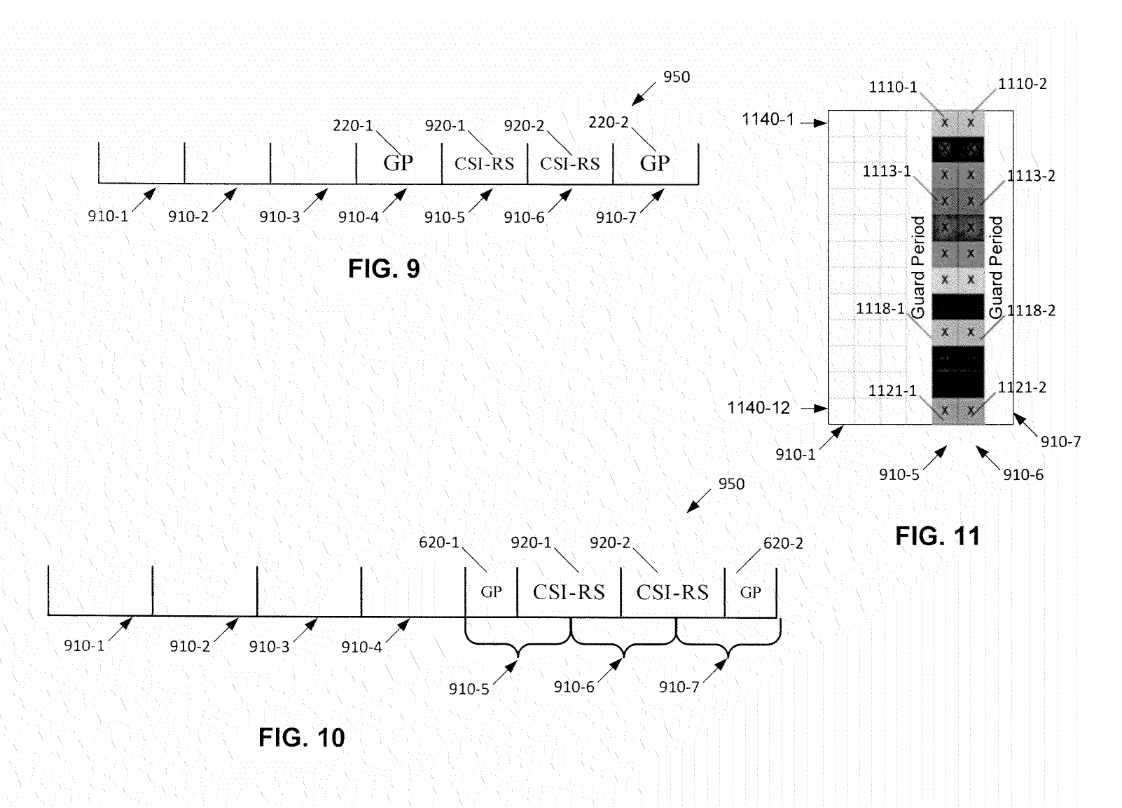

Regarding FDD UL-frequency sounding by the eNB 107, in the future the UE may also have an increased number of transmit antennas and/or could also benefit from high resolution CSI. In this case, the FDD uplink could get punctured to enable a short transmission from the eNB 107 in a manner similar to the FDD DL-frequency sounding. Again, some of the OFDM symbols would be punctured to enable this sounding and the sounding could occur on the same slot as the FDD DL-frequency sounding by the UE or on a different slot. The punctured OFDM symbols could use the same format as shown in FIGS. 2 and 6 or could use a different symbol puncturing such as illustrated by FIGS. 9 and 10.

FIG. 9 is an example of puncturing of a slot 950 for FDD UL-frequency sounding using CSI-RS for sounding. FIG. 9 in UL is similar to FIG. 2 in DL. In this example, the slot 950 includes seven UL symbols 910-1 through 910-7 where, for example, these UL symbols are OFDM or SC-FDMA symbols. and there are two GPs 220-1 and 220-2 in symbols 910-4 and 910-7, respectively. Further, there are two CSI-RS 920-1 and 920-2 in symbols 910-5 and 910-6, respectively.

FIG. 10 is an alternate example puncturing of a slot for FDD UL-frequency sounding using CSI-RS for sounding with smaller guard period. In this example, the slot 950 includes seven UL symbols 910-7 through 910-7, and there is a GP 620-1 that occupies half the length of symbol 910-5 and a GP 620-2 that occupies half the length of symbol 910-7. Further, there is a CSI-RS 920-1 that occupies half the length of the symbol 910-5 and half the length of the symbol 910-6. There is a CSI-RS 920-2 that occupies half the length of the symbol 910-6 and half the length of the symbol 910-7.

The eNB 107 could use one of the following methodologies for FDD UL-frequency sounding: 1) the already-defined CSI-RS; 2) the already-defined UL SRS; or 3) a newly defined FDD UL-frequency SRS. An example of a newly defined FDD UL-frequency SRS which enables sounding up to 24 antennas is illustrated in FIG. 11. FIG. 11 illustrates CSI-RS-based FDD UL-frequency sounding for the format illustrated in FIG. 9. This sounding enables sounding of up to 24 transmit antennas. In FIG. 11, frequency is along the y-axis and time is along the x-axis.

For the CSI-RS design shown in FIG. 11, there are 12 pairs 1110 through 1121 of antennas, one pair for each subcarrier 1140-1 through 1140-12. One antenna (e.g., “-1” such as 1110-1 or 1118-1) transmits the same reference symbols at both times (for both symbols 910-5 and 910-6) and the other antenna (e.g., “-2” such as 1110-2 or 1118-2) transmits the negative of its reference symbol at the second time (for symbol 910-6). This design enables sounding of up to 24 transmit antennas where the pairs of antennas are separated through the code spreading across the two symbols. This type of reference signal design is referred to as being orthogonal in time between pairs of antennas. Note that the reference signal design is also orthogonal in frequency between the antenna pairs. If needed, more antennas could be accommodated by adding more pairs in frequency, time, or with sequence scrambling.

As with FDD DL-frequency sounding, the exact location and duration of the FDD UL-frequency sounding should be configured through control channel messaging specifying, e.g., the slot number and OFDM or SC-FDMA symbol numbers for the sounding. Also the exact structure of the sounding (e.g., number of transmit antennas) should be signaled to the UE as is the case currently with CRS and CSI-RS.

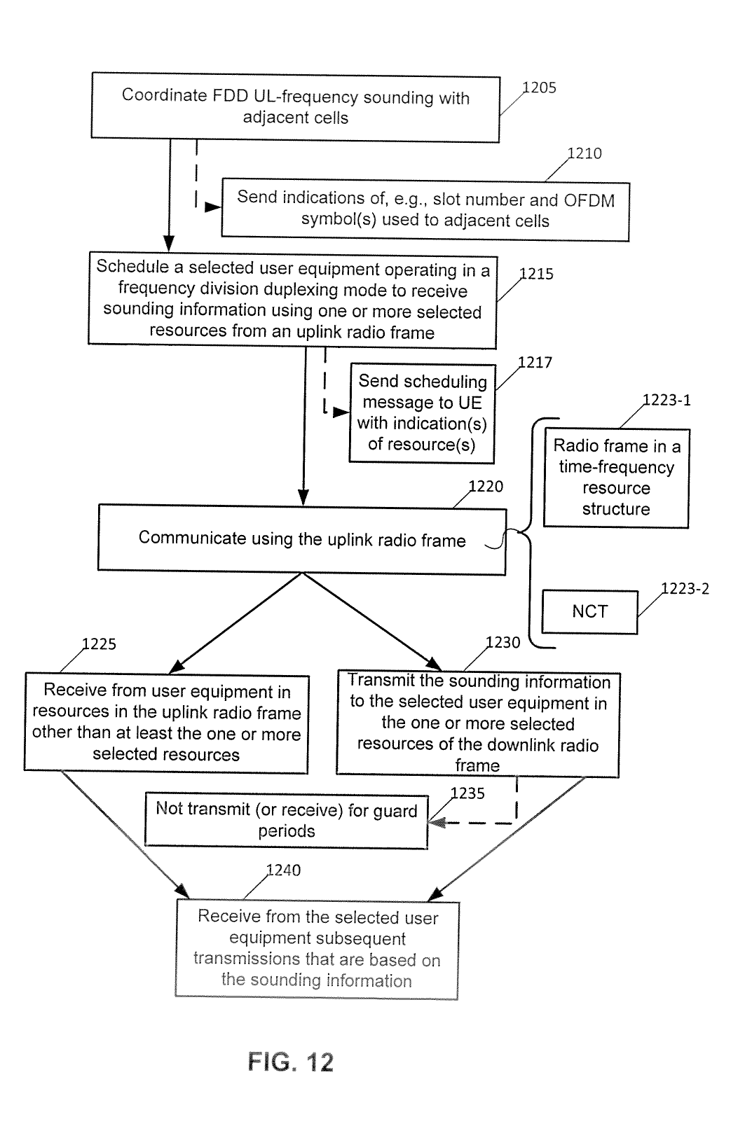

Referring to FIG. 12, this figure is a block diagram of an exemplary logic flow diagram performed by a base station for FDD UL-frequency sounding. This figure further illustrates the operation of an exemplary method, a result of execution of computer program instructions embodied on a computer readable memory, and/or functions performed by logic implemented in hardware, in accordance with exemplary embodiments herein. The blocks in FIG. 12 may be considered to be interconnected for means of performing the function in the blocks. The blocks of FIG. 12 are assumed to be performed by the eNB 107, e.g., under control of the high resolution channel sounding process 170.

Blocks 1205 and 1210 are similar to blocks 705 and 710, except that FDD UL frequency sounding is being coordinated in blocks 1205 and 1210 (whereas FDD DL-frequency sounding is coordinated in blocks 705 and 710). Therefore, the indications in block 1210 could describe, e.g., the structures shown in FIGS. 9 and 10.

Although blocks 1205 and 1210 are similar to blocks 705 and 710, for FDD UL-frequency sounding (where the eNB transmits to the UE on UL frequencies), the concern is different from the concern for DL-frequency sounding (where the UL transmits to the eNB on DL frequencies). The concern for FDD UL-frequency sounding is a near-far problem where a UE in the adjacent cell is transmitting on a normal UL but is still relatively close to the UE which is receiving the FDD UL-frequency sounding signal from its eNB. Consider a scenario where the UE receiving the UL-frequency sounding is near a cell edge and the other UE (transmitting on a normal UL) is also near its cell edge and hence is transmitting with full power. So some coordination is still useful for certain system 100 configurations even for FDD UL-frequency sounding.

In block 1215, the eNB 107 schedules a selected user equipment operating in a frequency division duplexing mode to receive sounding information using one or more selected resources from an uplink radio frame. Such scheduling may include (block 1217) sending a scheduling message to the UE 110 with the indication(s) of the resource(s) to be used by the UE for UL-frequency sounding. Since the eNB can be heard by all UEs attached to the eNB, the FDD UL-frequency sounding could be destined for all UEs in the cell. Hence a single broadcast control message could be used to signal FDD UL-frequency sounding is enabled and which time-frequency resources are reserved for the sounding.

In block 1220, the eNB 107 communicate using the uplink radio frame 950. The uplink radio frame 950 may be a radio frame in a time-frequency resource structure (block 1223-1) or an NCT frame (block 1223-2).

Block 1220 includes both blocks 1225 and 1230. In block 1225, the eNB 107 receives from user equipment in resources in the uplink radio frame 950 other than at least the one or more selected resources. For instance, the eNB 107 may receive from the selected UE or other UEs. In block 1230, the eNB 107 transmits the sounding information to the selected user equipment in the one or more selected resources of the downlink radio frame. In the examples of FIGS. 9 and 10, the sounding information is CSI-RS 920-1 and 920-1 and the eNB uses the structures shown in these figures to receive. Thus, in block 1235, the eNB (e.g., as part of block 1230) will not transmit (or receive) for the guard periods 220, 620. In block 1240, the eNB 107 receives from the selected user equipment subsequent transmissions that are based on the sounding information.

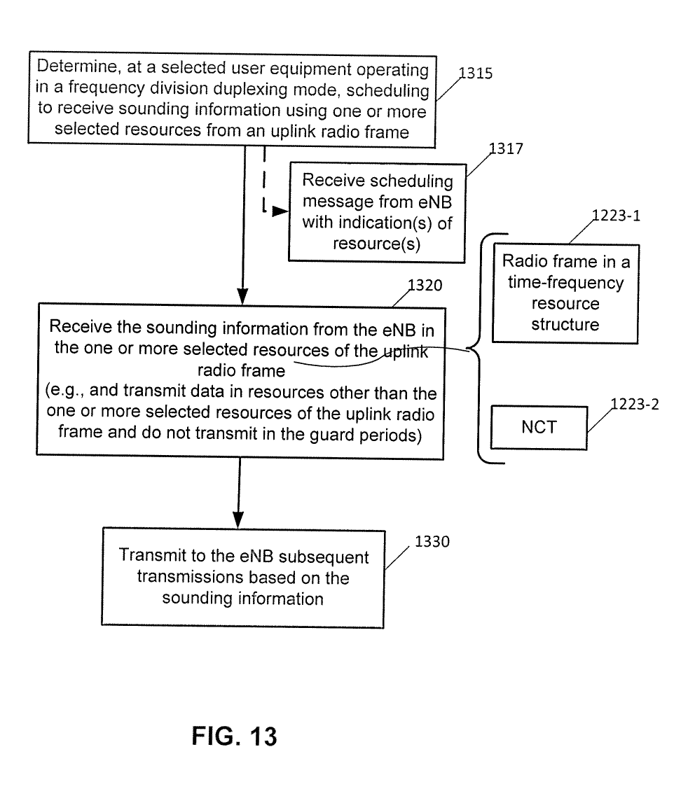

Turning to FIG. 13, FIG. 13 is a block diagram of an exemplary logic flow diagram performed by a user equipment for FDD UL-frequency sounding. This figure illustrates the operation of an exemplary method, a result of execution of computer program instructions embodied on a computer readable memory, and/or functions performed by logic implemented in hardware, in accordance with exemplary embodiments herein. The blocks in FIG. 13 may be considered to be interconnected for means of performing the functions in the blocks. FIG. 13 is performed by a UE 110, e.g., under control of a high resolution channel sounding process 180.

In block 1315, the UE 110 determines, at the selected user equipment operating in a frequency division duplexing mode, scheduling to receive sounding information using one or more selected resources from an uplink radio frame. The scheduling may be received, e.g., in block 1317, as a scheduling message from the eNB with the indication(s) of the resource(s).

In block 1320, the UE 110 receives the sounding information (e.g., CSI-RS 910 of FIG. 9) from the eNB in the one or more selected resources (e.g., OFDM or SC-FDMA symbols 910-5, 910-6, 910-7 of FIG. 9) of the uplink radio frame. Examples of sounding structures are shown in FIGS. 9 and 10. The uplink radio frame may be the frames 1223-1 or 1223-2. Block 1320 also entails the UE 110 possibly transmitting data in resources other than the one or more selected resources of the uplink radio frame and not transmitting in the guard periods. In block 1330, the UE 110 transmits to the eNB subsequent transmissions based on the sounding information. For instance, the sounding information may be used to apply precoding to antennas 128 of the UE 110.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1A. A computer-readable medium may comprise a computer-readable storage medium (e.g., memory(ies) 155 or other device) that may be any media or means that can contain or store the instructions for use by or in connection with an instruction execution system, apparatus, or device, such as a computer. A computer readable storage medium does not, however, encompass propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

3GPP Third Generation Partnership Project

μsec microseconds

CQI Channel Quality Indicator

CRS Common Reference Symbols

CSI Channel State Information

CSI-RS Channel State Information Reference Signal

D2D Device to Device

DL Downlink (from a base station to a UE)

eNB evolved Node B (e.g., LTE base station)

FDD Frequency Division Duplexing

GP Guard Period

km kilometer(s)

LoS Line of Sight

LTE Long Term Evolution

MBSFN Multicast-Broadcast Single Frequency Network

MIMO Multiple Input, Multiple Output

MU Multi-User

NCT New Carrier Type

OAM Operations, Administration and Maintenance

OFDM Orthogonal Frequency-Division Multiplexing

PMI Precoding Matrix Indication

Rel or R Release

RF Radio Frequency

RS Reference Signal

SC-FDMA Single-Carrier Frequency-Division Multiple Access

SRS Sounding Reference Symbol

Rx Reception or Receiver

SU Single-User

TDD Time Division Duplexing

TS Technical Standard

Tx Transmission or Transmitter

UE User Equipment (e.g., mobile device)

UL Uplink (from a UE to a base station)

UpPTS Uplink Pilot Time Slot

What is claimed is:

1. An apparatus, comprising:
one or more processors; and
one or more memories including computer program code,
the one or more memories and the computer program code configured, with the one or more processors, to cause the apparatus to perform at least the following:
scheduling a selected user equipment operating in a frequency division duplexing mode to transmit sounding information on a downlink carrier frequency using one or more selected resources from a downlink radio frame; and
communicating using the downlink radio frame by transmitting to user equipment in resources in the downlink radio frame other than at least the one or more selected resources and by receiving the sounding information on the downlink carrier frequency from the selected user equipment in the one or more selected resources of the downlink radio frame.

2. The apparatus of claim 1, wherein communicating further comprises not transmitting on guard periods occupying resources adjacent to the one or more selected resources of the downlink radio frame.

3. The apparatus of claim 1, wherein the one or more memories and the computer program code are further configured, with the one or more processors, to cause the apparatus to perform at least the following: prior to communicating, coordinating with adjacent cells the scheduling of the selected user equipment operating in the frequency division duplexing mode to transmit sounding information using the one or more selected resources from a downlink radio frame.

4. The apparatus of claim 1, wherein the radio frame is one of the following: a radio frame in a time-frequency resource structure, a radio frame comprising a multicast-broadcast single frequency network subframe, or a radio frame comprising a new carrier type frame.

5. The apparatus of claim 1, wherein the one or more memories and the computer program code are further configured, with the one or more processors, to cause the apparatus to perform at least the following: using the received sounding information to tailor transmission of a future downlink transmission to the user equipment.

6. An apparatus, comprising:
one or more processors; and
one or more memories including computer program code,
the one or more memories and the computer program code configured, with the one or more processors, to cause the apparatus to perform at least the following:
determining, at a user equipment operating in a frequency division duplexing mode, scheduling requesting the user equipment transmit sounding information on a downlink carrier frequency using one or more selected resources from a downlink radio frame; and
transmitting the sounding information from the user equipment on the downlink carrier frequency in the one or more selected resources of the downlink radio frame.

7. The apparatus of claim 6, wherein the transmitted sounding information comprises sounding reference symbols sent on the downlink carrier frequency from at least one transmit antenna that is a same as at least one antenna used to the receive regular downlink transmissions.

8. The apparatus of claim 6, wherein transmitting further comprises transmitting the sounding information using an orthogonal frequency division multiplexing symbol occupying a symbol length of an orthogonal frequency division multiplexing symbol in the downlink radio frame.

9. The apparatus of claim 6, wherein the radio frame is one of the following: a radio frame in a time-frequency resource structure, a radio frame comprising a multicast-broadcast single frequency network subframe, or a radio frame comprising a new carrier type frame.

10. An apparatus, comprising:
one or more processors; and
one or more memories including computer program code,
the one or more memories and the computer program code configured, with the one or more processors, to cause the apparatus to perform at least the following:
scheduling a selected user equipment operating in a frequency division duplexing mode to receive sounding information on an uplink carrier frequency using one or more selected resources from an uplink radio frame; and
communicating using the uplink radio frame by receiving from user equipment in resources in the uplink radio frame other than at least the one or more selected resources and by transmitting the sounding information on the uplink carrier frequency to the selected user equipment in the one or more selected resources of the uplink radio frame.

11. The apparatus of claim 10, wherein communicating further comprises not transmitting on guard periods occupying resources adjacent to the one or more selected resources of the uplink radio frame.

12. The apparatus of claim 11, wherein each of the guard periods and the sounding information comprises an orthogonal frequency division multiplexing symbol.

13. The apparatus of claim 10, wherein the one or more memories and the computer program code are further configured, with the one or more processors, to cause the apparatus to perform at least the following: prior to communicating, coordinating with adjacent cells the scheduling of the selected user equipment operating in the frequency division duplexing mode to receive sounding information using the one or more selected resources from a uplink radio frame.

14. The apparatus of claim 10, wherein coordinating further comprises sending to the adjacent cells indications of at least one or more slot numbers and one or more uplink symbols to be used by the selected user equipment operating in the frequency division duplexing mode to receive sounding information.

15. The apparatus of claim 14, wherein the uplink symbols are one of orthogonal frequency division multiplexing symbols or single-carrier frequency-division multiple access symbols.

16. The apparatus of claim 10, wherein the radio frame is one of the following: a radio frame in a time-frequency resource structure, a radio frame comprising a multicast-broadcast single frequency network subframe, or a radio frame comprising a new carrier type frame.

17. An apparatus, comprising:
one or more processors; and
one or more memories including computer program code,
the one or more memories and the computer program code configured, with the one or more processors, to cause the apparatus to perform at least the following:
determining, at a user equipment operating in a frequency division duplexing mode, scheduling from a base station requesting the user equipment receive sounding information on an uplink carrier frequency using one or more selected resources from an uplink radio frame; and
receiving the sounding information sent on the uplink carrier frequency from the base station in the one or more selected resources of the uplink radio frame.

18. The apparatus of claim 17, wherein the one or more memories and the computer program code are further configured, with the one or more processors, to cause the apparatus to perform at least the following: using the received sounding information to tailor the transmission of a future uplink transmission to the base station.

19. The apparatus of claim 17, wherein receiving further comprises receiving the sounding information using one or more orthogonal frequency division multiplexing symbols, each occupying one-half of a symbol length of a first orthogonal frequency division multiplexing symbol in the uplink radio frame and one-half of a symbol length of a second orthogonal frequency division multiplexing symbol in the uplink radio frame.

20. The apparatus of claim 17, wherein the radio frame is one of the following: a radio frame in a time-frequency resource structure, a radio frame comprising a multicast-broadcast single frequency network subframe, or a radio frame comprising a new carrier type frame.
